(19) United States
(12) Patent Application Publication
(10) Pub. No.: US 2004/0250286 A1
(43) Pub. Date: Dec. 9, 2004

(54) System for communication of streaming digital data

(76) Inventors: Allistair M Fraser, North Vancouver (CA); Craig S Hamilton, Vancouver (CA); Vince Hodges, Pitt Meadows (CA); Jeffrey Beis, Vancouver (CA)

Correspondence Address: Kenneth C Hill, Suite 1440, 201 Main Street, Fort Worth, TX, 76102, US

(21) Appl. No.: 10/480,888

(22) PCT Filed: Jun. 14, 2002
(86) PCT No.: PCT/US02/19055

Related U.S. Application Data
(60) Provisional application No. 60/298,818, filed on Jun. 15, 2001.

(51) Int. Cl. H04N 7/173; H04N 7/16

(52) U.S. Cl. 725/89; 725/134; 725/142; 725/115

(57) ABSTRACT

Identical copies of a streaming program are stored on multiple sources. A client sets up multiple connections with a subset of the sources, and obtains a portion of the streaming program from each source. Because each source supplies only a small portion of the program, upload demands on each source are minimised. The client assembles the received data into a single data stream, reproducing the original file for access.

### TECHNICAL FIELD

The present invention relates generally to communications over a wide band network such as the Internet, and more specifically to a system and method for streaming data over the network such as the Internet.

### DESCRIPTION OF THE PRIOR ART

As the Internet becomes more and more common, different types of data are being transmitted over it. One type of data transmission that is becoming more popular is often referred to as “streaming” transmission. In this type of data transfer, a large amount of data is transmitted over the Internet to a receiving client at rates that allow the information to be accessed in real time.

Common examples of data streamed over the Internet include audio and video. Radio stations and other types of audio sources are widely streamed over the Internet to a large number of receiving clients in a manner that approximates broadcasting of this information. Similar transmission may be accomplished with video. The streams data may be digitized live transmissions, or it may be transmissions of prerecorded and pre-stored files. For example, transmission of prerecorded musical and video programs can be performed over the Internet to a large number of receiving client, and it in ot necessary that these client receive the programs simultaneously.

Presently, each receiving client receives its streaming digital data from a single source, generally a server connected to the Internet. While this makes it easy for the client to communicate with the source during streaming, several difficulties can arise. One difficulty arises if the source is unable to supply data at a high enough data rate to meet the real-time needs of the streaming program. This situation is sometimes caused because many systems are set up and optimized for high download speeds and relatively low upload speeds. Also, this situation can occur when a source is serving a large number of requests simultaneously.

Another problem with the use of a single source is that an interruption in the link between source and client, or failure of the source, interrupts the streaming program received by the client. It normally takes a significant amount of time for the client to find a backup source, assuming one is available at all. Then, the client must communicate with the new source to restart the program.

It would be desirable to provide a system and method for streaming digital data between sources and clients that allows for improved data transfer, better redundancy, and solution to problems encountered in prior art systems.

### SUMMARY OF THE INVENTION

In accordance with the present invention, identical copies of a streaming program are stored on multiple sources. A client sets up multiple connections with a subset of the sources, and obtains a portion of the streaming program from each source. Because each source supplies only a small portion of the program, upload demands on each source are minimized. The client assembles the received data into a single data stream, reproducing the original file for access.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating connection of multiple sources and clients to a wide area network such as the Internet;

FIG. 2 is a block diagram illustrating perceived to have multiple channels by a single client;

FIG. 3 is a high level block diagram of the use of an input buffer within a client;

FIG. 4 is a diagram illustrating division of a streaming data file;

FIG. 5 is a schematic block diagram of data handling using a ring buffer within a client;

FIG. 6 illustrates placement of data within selected regions of a ring buffer;

FIG. 7 is a block diagram illustrating an example of sharing of a streaming program; and

FIG. 8 is a block diagram similar to FIG. 7 illustrating changes made to the example thereof as a result of changes in operating conditions relative to the system.

### DESCRIPTION OF THE PREFERRED EMBODIMENT

The present invention is especially suitable for use with streaming media files, such as audio or video files, over a wide area network such as the Internet. Generally, it is desirable to view or listen to these files in real time as they are streamed, rather than downloading an entire file to a client computer before reproducing it.

For convenience of explanation in the following description, the preferred embodiment will be described in connection with a system and method for streaming audio data over the Internet. It will be apparent to those skilled in the art that the invention may be practiced over other networks, and using other types of streaming data such as video. Streaming of audio and video data generally is well known in the art; the present invention provides an improvement in the techniques and method for streaming such data.

FIG. 1 is a high level diagram describing the environment in which the present invention may be used, A number of computer systems are connected to the Internet as known in the art. FIG. 1 shows four systems, 12, 14, 16, 18 connected to the Internet 10. In addition, three client systems 20, 22, 24 are also connected to the Internet 10.

As referred to herein, a client is a system or user that makes a request to stream a desired file, generally so that the file may be reproduced. A source is a system that contains a copy of a file desired by a client. As understood by those skilled in the art, a single computer system can operate as both a source and a client. In fact, some systems may operate simultaneously as multiple sources and/or multiple clients, depending upon their configuration. For purposes of the following discussion, sources and clients will be treated as independent entities, without reference to the physical hardware on which they reside.

Each client may have multiple channels of Input provided to it. This is indicated in FIG. 2, where client 20 currently has three separate input channels. Normally, client 20 has only a single connection to the Internet, and may in fact be sharing a single physical connection with additional clients residing on a single piece of hardware. The physical connection can be treated as broken into a number of logical connections, each of which is referred to herein, and indicated in FIG. 2, as a channel.

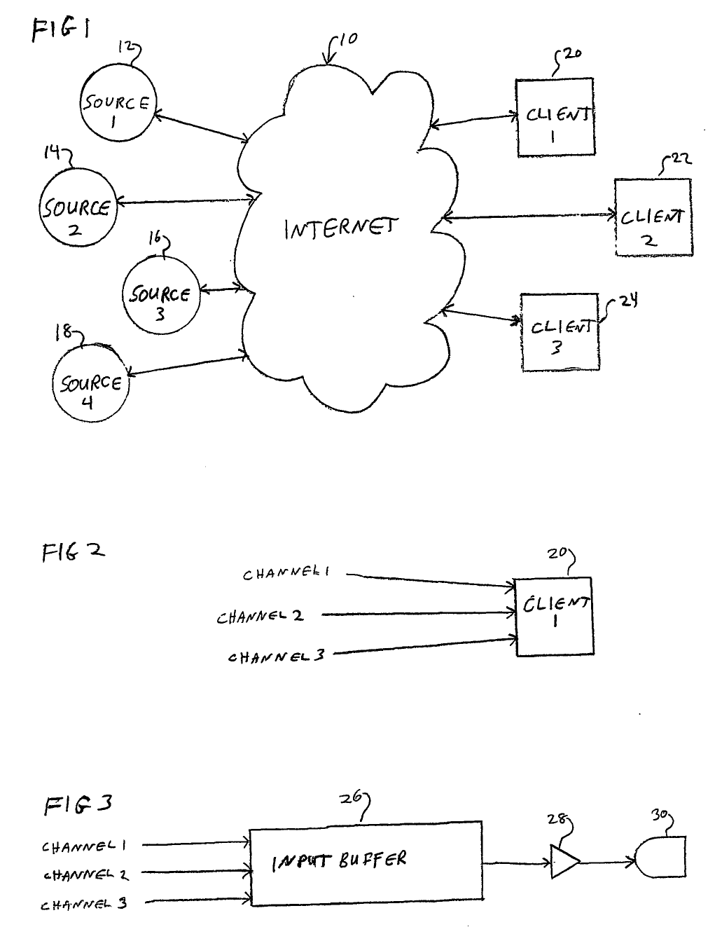

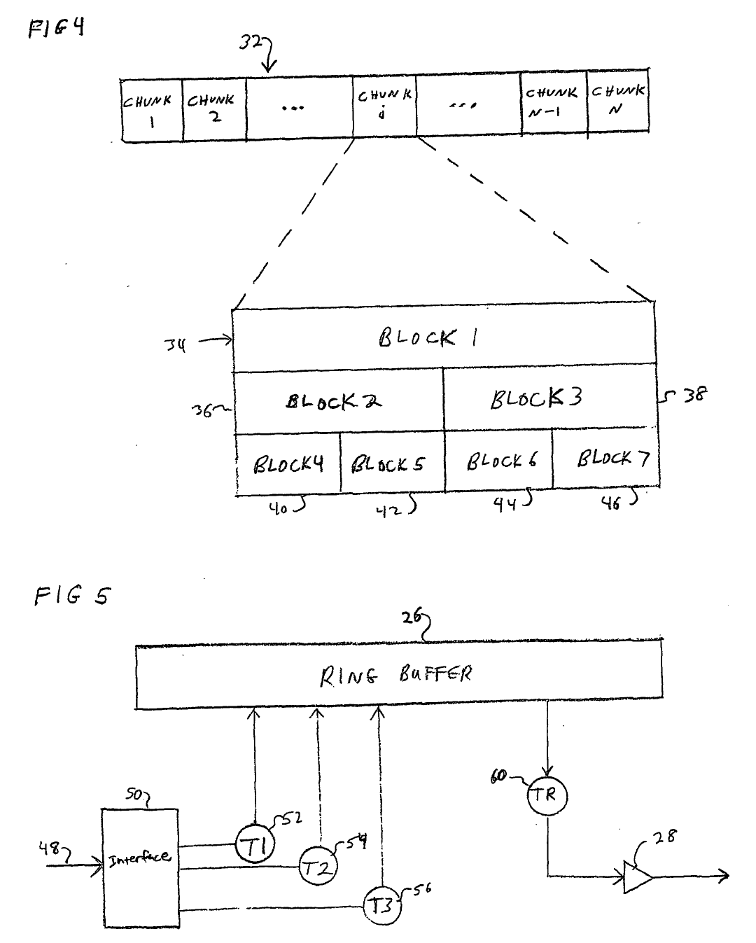

Referring to FIG. 3, within client 1 the three input channels provide information that is placed into a single input buffer 26. Input buffer 26 is preferable a circular buffer of any of several types well known in the art. As described below, each channel places data into appropriate portions of input buffer 26, with the data being read out of input buffer 26 by an appropriate process. Data read out of input buffer 26 is transmitted to an appropriate buffer/converter 28, which provides an output which is transmitted to reproducer 30. Reproducer 30 can be, for example, a speaker system for an audio program, or a monitor or other reproducer for a video program. Operation of converter 28 and reproducer 30 are conventional.

Conceptually, the contents of a streaming data file and the contents of input buffer 26 are broken into various types of blocks for efficient handling and consideration. For purposes of the following discussion, a data file 32 will be considered to be broken into a plurality of chunks as shown in FIG. 4. File 32 is illustrated as having “N” chunks. All chunks are of a pre-defined size. The size of a chunk may be either a fixed length in bytes, or may depend upon various aspects of the underlying file format. An example of the latter situation is a case wherein the file is already broken into well-defined pieces, such as frames. In the event that the underlying file format allows frames of varying length, the chunks may also be of corresponding varying length. For ease of the following description, chunks will be presumed to be of fixed size.

Each chunk is conceptually broken into one or more blocks as shown. For simplification of explanation and numerical calculation, blocks are preferably numbered as shown in FIG. 4. However, other block organization schemes can be used with the present invention.

At the highest level, each chunk corresponds to a block equal in size to that of the chunk, referred to as block 1 34. Block 2 36 and block 3 38 together equal block 1. Block 2 36 can be broken into block 4 40 and block 5 42, while block 3 38 can be broken up into block 6 44 and block 7 26.

Additional layers of block subdivisions (not shown) can be used to define further granularity for the chunk. For example, block 8 and block 9 together correspond to block 4, and so forth. A chunk is completely defined by an appropriate section of non-overlapping blocks that fill the chunk. For example, a combination of block 2, block 6, and block 7 completely define each chunk in file 32. Each chunk within the file 32 is conceptually broken into the same block scheme.

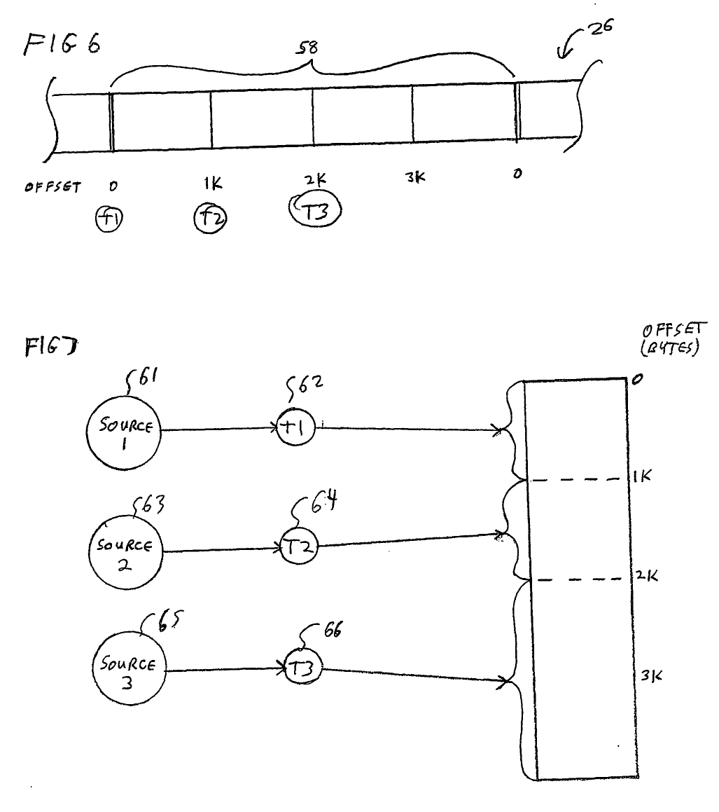

FIG. 5 illustrates how ring buffer 26 is used to store streaming data sent to a single client. Initially, each client will need to determine which sources are supplying data to it and which block number of each chunk is being supplied by which source. Preferably, each separate source supplies a single block for each chunk within the streaming file, although some sources can provide two or more blocks if desired. For purposes of the following analysis, a single source providing two separate blocks can be treated as two separate sources.

All streaming data being made available for a particular client is provided through logical input port 48 through interface 50. The data is transmitted through multiple logical channels as described above, each channel being provided by a source. Each channel corresponds to one block as described in connection with FIG. 4. Each channel is read by a separate, independent thread operating within the client, and the thread places the data received through its channel to an appropriate location within ring buffer 26.

As an example, three channels are provided in FIG. 5. These are read by three threads, 52, 54, 56. Threads 52 and 54 can be providing, for example, block 4 and block 5 of each chunk, with thread 56 providing block 3. Each thread 52-56 places each received block into its appropriate position within ring buffer 26.

Ring buffer 26 has a size that is an integer multiple of the chunk size. Each block of data received from a source by any thread contains with it an identifier of a chunk number that the block of data goes into, and the length of the block. By using the chunk numbers provided in data headers, threads 52-56 place the received data into the appropriate location within ring buffer 26. As is known in the art, it is possible that any particular thread will receive its data blocks out of order, and it is necessary that each block be placed in the appropriate chunk in order to properly reproduce the original file. Because each thread is assigned a particular block within each chunk, there is no conflict between the individual threads as to where data is written.

An example of this is shown in connection with FIG. 6, in which a single chunk within ring buffer 26 is illustrated as region 58. In this example, each chunk has a length of 4K bytes. Thread T1 is defined to be block 4, which is the beginning block within each chunk and ¼ the size of each chunk. Thus, thread T1 writes its data into ring buffer 26 at offset 0 within each chunk 58.

In a similar manner, thread T2 writes its data into each chunk with a 1K offset, and thread T3 writes its data into each chunk with a 2K offset. Because thread T3 receives block 3 within each chunk, it writes a block of 2K length into the chunk 58. Between them, these three threads provide all of the data necessary of fill up chunk 58.

Because each thread writes data into a fixed region within each chunk, it is not important that data be written into ring buffer 26 at any particular order. It is only important that the data all eventually be written into ring buffer 26, and that this be done prior to the time that it becomes necessary to read the data out of ring buffer 26.

Returning to FIG. 5, a reader thread 60 is provided to read data out of ring buffer 26 in a conventional manner. Thread 60 reads data out of ring buffer 26 at a rate that is necessary to keep converter 28 supplied with data. As known in the art, if ring buffer 26 should empty, reader thread 60 will have no data to read and output of the streaming file will be interrupted. In a proper design, ring buffer 26 will be large enough, and data provided at an adequate rate, so that this never occurs.

In addition to the terms defined above, the following description of system operation will utilize the following defined terms: consumption rate (CR) is the rate at which the client will consume the streamed data. This may be represented in kilobits/sec. The scaled consumption rate (SCR) is the fraction of the consumption rate that a given source is required to supply. The sum of the scaled consumption rates for all of the sources is equal to the consumption rate.

A streaming data process is initiated when a user selects a file to be streamed. This typically happens when a human user clicks on a button or link that identifies the file to be streamed. Based upon the user's request, a unique identifier for the file is computed. A message is sent to a central server requesting an array of sources known to hold a copy of the requested file. The server returns an array of source identifiers to the requesting client.

The client then requests blocks from some or all of the available sources. Requests to each source identify the file to be streamed, and the block to be transferred so that all blocks are transferred in parallel as previously described. Each incoming block contains a header identifying the chunk to which it is associated so that all chunks are assembled in the proper order. Data is read from the stream buffer at the consumption rate.

In order to ensure that a perfect file results from this process, the file copies at each source must all be identical. Also, the sources must be able to use the same blocking scheme in order that each source correctly locates the block of data it is transferring to the client.

When the request is sent to the central server, such central server must determine which sources contain the file being requested, and return them to the client. In the case of a file which is stored on numerous sources, only a subset of all available sources may be provided. Alternatively, all available sources can be provided to the client, with the client selecting a desired subset.

Preferably, the client selects sources as will now be described. The client has a set of N sources for the desired file. A subset of S sources (S<=N) is chosen as the active set. The unused sources are referred to as “dormant” sources. The number of active sources is selected as

S=Max(16, 2\hat{ }(floor(log_{—}2(n)))) (Eq. 1)

where floor (x) is the largest integer value not greater than x. In Eq. 1, the maximum number of sources to stream from is 16, but this number can be changed according to implementation specific requirements.

A block number is assigned to each of the S active sources. As previously described in connection with FIG. 4, the block number uniquely indicates which portion of each chunk that a source must supply. In the preferred embodiment, the size of a block is limited to be 1/(2\hat{ }i) of a chunk, where i is an integer. Let

f=2\hat{ }(floor(log_{—}2(n))) (Eq. 2)

s=n−f+1 (Eq. 3)

A block index of n then indicates that a source must supply a fraction (1/f of each chunk, and that the specific block is the s'th block within each chunk. A request is sent to each of the S sources with the requested block number and the starting chunk number, which will normally be the first chunk of the file. Each source then streams its appropriate block for all chunks of the file, in sequence, until it is interrupted or the end of the file is reached.

Other schemes for determining each which blocks of each chunk are provided by each source may be implemented as desired. For example, instead of a rigidly defined scheme of blocks as previously described, it may be desirable or necessary to specify each block by a length and offset parameter to be sent to each source. This would increase flexibility by allowing block sizes that are not multiples of twos to be used, but enhances complexity by requiring each source to be capable of supplying blocks of any requested length. Normally, for reasons of simplicity and efficiency, a predefined scheme such as previously described is desired.

The header for each block provided from a source preferably includes both a block number and a chunk number. This allows the appropriate thread to be able to select the block and place it in the proper location within the ring buffer as previously described.

It is possible for the sources to provide dynamic switching among themselves of the block requirements being transferred. As just described, each source is initially supplied with its own scaled consumption rate which must be satisfied. Each source then monitors itself to make sure that it is streaming data fast enough. Each source will know the consumption rate for the file in terms of chunks per second, or a measure convertible to chunks per second. If any particular source is transmitting its blocks at a rate at least as fast as the consumption rate, that source is keeping up with demand. If the source is, for whatever reason, unable to supply blocks fast enough to meet the consumption rate, then that source must either be replaced, or must scale down and provide a smaller sized block. This is will require another source to provide the remaining portion of the block previously supplied by the source that was unable to keep up.

In the preferred embodiment, if the source determines that it is not feeding data faster than 1.1(SCR), it decides to “split.” This means that the source will henceforth supply only ½ of the data it was previously supplying. The client is notified of this split when the server returns the reduced data block, which is indicated by a returned block number in the header of 2N (assuming the source was originally supplying block N).

Preferably, the server will not split if it is more than a specified distance (in time) ahead of the client's consumption point. This can be set to, for example, fifteen seconds. The distance a source is ahead of the consumption point can easily be computed at each source using its SCR, the time it has been streaming, and the amount of data that has been streamed. If the block size is already too small, a source will sign off by sending an appropriate indicator back to the client instead of splitting. This can be done, for example, by sending a block value of −1 in the block header. If a maximum of sixteen sources is established, the smallest corresponding block size would be 1/16 of a chunk.

When the client detects that a source has split, or has signed off, it must find an alternative source for the now unsupplied data. If there is a dormant source available, the client will establish communication with that source and provide it with a starting chunk number that is necessary to ensure that there are no gaps. If no dormant sources are available, a client will use whichever source is currently the furthest ahead in supplying data to also supply the missing block.

When an alternative source is required, the new block number is 2N+1 if the original source, supplying the block N, split. This would leave the original source now supplying block 2N, and the new source supplying block 2N+1. Together, these blocks are identical to the block number N which was split. If a source signed off, the new block is identical to the old block N.

It can be seen that this dynamic switching of sources occurs without communication between the sources, and with minimal communication between source and client. If a source makes a decision to split or sign off, the client simply contacts the appropriate new source to replace the missing data. Over the course of time, it is possible that many or all of the original sources could be replaced, and this would happen without interruption of the streamed data.

In addition to the sources ensuring that they are keeping up, the client monitors each source to ensure that it is receiving adequate streams of data. If any sources are under-performing, the client will drop that source. Preferably, the criterion for dropping the source is the same as that used by the sources, 1.1 (SCI). If a client decides to drop its source, it determines an alternate source as previously described. If the client drops a source, the entire source is replaced as opposed to any type of splitting process taking place.

The examples described above use a multiplier of 1.1 to ensure that all sources are feeding data fast enough to keep the ring buffer relatively full. Depending upon system requirements, this number could be increased or decreased. In any event, all sources should be set up to provide data to the ring buffer at a rate greater than the consumption rate so that the ring buffer does not gradually become starved of data.

Supplying data at faster than the consumption rate will eventually cause the ring buffer to become full. A progressive wait mechanism is needed to prevent unused portions of the ring buffer from being overwritten. After each read of k Kbytes from a given source, a wait is introduced before the next read of the same source, equal to (i) 0 seconds if the source is less than 45 seconds ahead, (ii) ((n−45)/45)*(k/CR) seconds if the source is n seconds ahead, 45<n<90, and (iii) (k/CR) if the source is greater than 90 seconds ahead. The sources keep track of how far ahead they are in the file, and ignore this wait when determining their performance to see if they are keeping up. A wait is performed by having the thread that needs to wait simply sleep for a predetermined period.

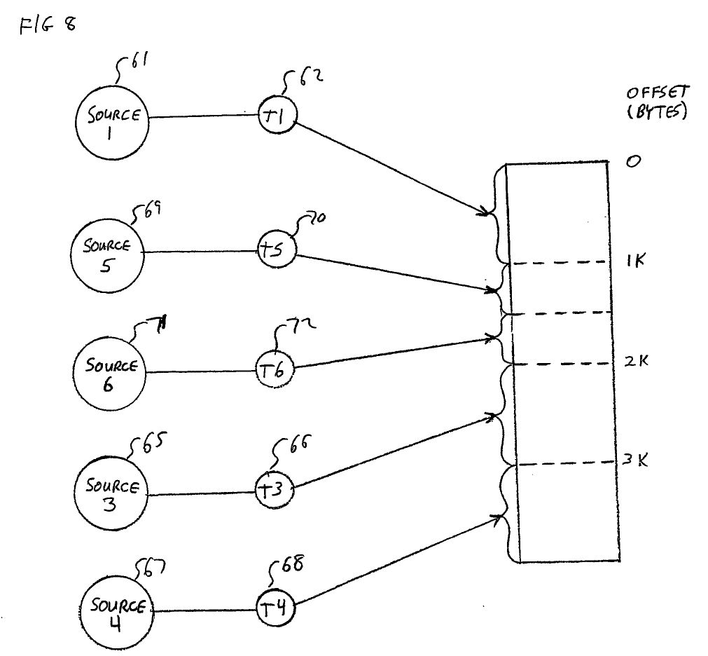

An example of how sources and clients ensure an uninterrupted stream of data is given with respect to FIGS. 7 and 8. Referring to FIG. 7, it is presumed that each chunk is 4K bytes long, and that three sources have been selected to initially supply data. The data provided by sources 61,63,65 is respectively read by threads 62, 64, 66. Each of threads 62 and 64 provide 1K blocks of data, with thread 66 providing a 2K block of data. With reference to FIG. 4, this would correspond to threads 62 and 64 providing blocks 4 and 5, with thread 66 being associated with block 3.

Referring to FIG. 8, after the file has been streaming for a period of time, assume that source 3 determines that it is unable to feed data fast enough. Source 3 then initiates a split and begins sending only a 1K block of data to the client, identified as block 6. Upon receipt of the first shorter block transmitted by source 3, the client finds another available source, source 4 67, and initiates thread 68 to read it. Source 4 begins supplying block 7 of the chunk, corresponding to the last 1K block of data, beginning with the chunk number that was first split by source 3.

At a later time, it is determined that source 2 must sign off. This can be caused by either a sign off of source 2, or a determination by the client that source 2 is not keeping up with its required data rate. A new source 69 is then selected, and associated with thread 70 to place data into the second 1K block of data within each chunk. At yet a later time, source 69 determines that it is unable to keep up with its required data rate, and splits as previously described. When the first block is received that indicates that source 69 has split, the client must find a new source 71 to supply the second half of the block previously provided by source 69. It associates thread 72 with that source, and provides data as shown in FIG. 8.

At the end of this sequence, source 1 remains unchanged while source 3 has cut its data rate in half. Source 2 has been disconnected, and new sources 4,5, and 6 have been added in. During the course of this switching of sources, no data has been lost, and the real time data stream has been uninterrupted.

All the operations described above can be formed at a relatively high level within both the sources and clients. Data may be transferred using HTTP protocols, with handshaking and waits for each data transfer being handled by the underlying systems as known in the art. Multiple sources are selected to provide various portions of a streaming data program, with these portions being properly reassembled in a buffer at the client. If a source must cut its data supply, it simply does so and the client is able to find an appropriate alternate source. If the client finds that a source is unable to keep up, it also is able to find an appropriate alternative source.

The techniques previously described are especially useful for streaming audio and video, but could be used for downloading of other data if desired.

In addition to allowing sources with limited bandwidth to provide streaming data to a relatively high bandwidth client, the system described above provides extra redundancy and reliability into the system. If, for example, streaming transmission is spread over 8 sources, and one of those sources fails for any reason, the client is able to reconfigure on the fly. This provides for enhanced capabilities to prevent interruption when streaming large files.

When a client is considered as receiving channels, each thread is considered to be reading an individual channel. The channels are dynamically changed and balanced in order to ensure that all sources can properly provide their share of the load in a timely manner. As long as it is possible to find a mix of sources that can provide data at a rate equal to or greater than the consumption rate, a client can receive and reproduce the streaming audio or video information with interruption.

While the invention has been particularly shown and described with reference to a preferred embodiment, it will be understood by those skilled in the art that various changes in form and detail may be made therein without departing from the spirit and scope of the invention.

1. A system for transferring data over a computer network, comprising:
a plurality of sources connected to the computer network;
a data file having identical copies stored on each source, the data file being divided into a sequence of consecutive chunks;
a client connected to the sources through the computer network;
a buffer within the client for temporarily storing data; and
means within the client for receiving blocks of data from each source, each source providing a data block for each file chunk, wherein the receiving means assembles the data blocks within the buffer to create a copy of the data file.

2. The system of claim 1, wherein the buffer contains, at any given time, only a portion of the data file.

3. The system of claim 1, further comprising:
a reproducer connected to the buffer, wherein data in the buffer is extracted therefrom and transferred to the reproducer.

4. The system of claim 3, wherein the reproducer drives an audio speaker, and the data in the data file represents streaming audio data.

5. The system of claim 3, wherein the reproducer drives a monitor, and the data in the file represents streaming video data.

6. A method for communicating data over a computer network, comprising the steps of:
connecting a plurality of sources to a client over the computer network, each source containing a copy of a data file, the data file being broken into chunks;
transmitting over the computer network data from the sources to the client, each source transmitting at least one block of data to the client, each such block containing a portion of each file data chunk, wherein the blocks transmitted by all of the sources represent all of the data in each chunk of the data file;
within the client, placing the blocks received from each source into a buffer so as to recreate the data file; and
reading data serially from the buffer to generate an output.

7. The method of claim 6, further comprising the steps of:
within a source, detecting whether such source is capable of providing data at a rate sufficient to keep the client buffer filled;
if such source is not capable of providing data at such a sufficient rate, changing data transmitted from such source to a smaller block; and
if a source changes the data transmitted to a smaller block, within the client establishing a connection to an additional source to supply some of the data previously supplied by the source not capable of providing data at the sufficient rate.

8. The method of claim 6, further comprising the steps of:
within the client, monitoring the rate at which data is provided by each source;
determining whether each source is providing data at a sufficient rate; and
if any source is not providing data at the sufficient rate, canceling the connection with such source and establishing a new connection with an additional source, wherein the data required to recreate the data file is uninterrupted.

9. The method of claim 6, wherein the data file represents a streaming audio file.

10. The method of claim 6, wherein the data represents a streaming video file.

11. The method of claim 6, further comprising the step of, after the reading step, converting the serial data to a form suitable for communicating to a human.
